(19) United States
(12) Patent Application Publication
(10) Pub. No.: US 2023/0037297 A1
(43) Pub. Date: Feb. 9, 2023

(54) Robotics Process Automation Automatic Enhancement System

(71) Applicant: Bank of America Corporation, Charlotte, NC (US)

(72) Inventors: Venkat Raman Parasuraman, Chennai (IN); MadhuSudhanan Krishnamoorthy, Tamil Nadu (IN); Palanivel Subramanian, Chennai (IN)

(21) Appl. No.: 17/396,629

(22) Filed: Aug. 6, 2021

(51) Int. Cl. G06F 9/451; G06F 8/30; G06N 3/02

(52) U.S. Cl. CPC G06F 9/451; G06F 8/315; G06N 3/02

(57) ABSTRACT

A robotics process automation (RPA) automatic enhancement system captures a video demonstration of task performance and converts the activity into nodes by a task specification encoder and a task interpreter and then process the nodes by a reformer transformer to automatically generate an enhanced RPA script. Once created, the RPA automatic enhancement system use a rules-based validation process to perform a quality review on the generated RPA script. The RPA automatic enhancement system may include a hierarchical reinforcement learner configured to use a recurrent neural network (e.g., a long short-term memory (LSTM) tensor flow network) along with one or more deep learning application programming interfaces within an interpreted language framework (e.g., Java).

### FIELD

Aspects described herein generally relate to computer systems and networks. More specifically, aspects of this disclosure relate to a system performing automated and dynamic process enhancements for robotics process automation.

### BACKGROUND

Aspects of the disclosure relate to managing resources of a cluster computing system. One or more aspects of the disclosure relate to an intelligent resource management agent capable of determining a complexity of each input file of a plurality of input files and allocating computing resources based on that determination.

In recent years, the development of versatile, autonomous robotics process automation (RPA) solutions have evolved through the introduction of means to intuitively teach RPA task-oriented behavior through requirements and/or high-level design. However, such means have failed to match efficiencies and/or the characteristics of processes designed by humans. For example, when humans perform a specific task, they may not always follow a same process. Often each repetition of a human process involves a high level of deviation from a standard process, where the degrees of freedom (DoF) available to execute the task is usually much higher than those required. In an illustrative example of a task to update a mainframe screen, the primary objective is to extract a data from a spreadsheet and place it in a field in mainframe screen. However, a business user, while performing the task manually, may copy all data into a notepad, apply a slight transformation, and transfer the data in a single import action, rather than saving each field value individually. In many cases, humans can adapt processes using specialized features of third-party tools and/or spreadsheet formula to improve an efficiency of repetitive tasks. Often humans will identify shortcuts that are not normally captured in requirements. Because of this, such shortcuts are often not anticipated or identified by automated process generation.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure provide effective, efficient, scalable, and convenient technical solutions that address and overcome the technical problems associated with automatically augmenting RPA scripts. For example, existing RPA scripts may be automatically augmented by efficiently capturing human-centric activity not captured in the existing RPA scripts using an Autotransformer transformation model. In doing so, the RPA automatic enhancement system may capture a video demonstration of task performance and convert the activity into nodes by a task specification encoder and a task interpreter and then process the nodes by a reformer transformer to automatically generate an enhanced RPA script. Once created, the RPA automatic enhancement system use a rules-based validation process to perform a quality review on the generated RPA script. The RPA automatic enhancement system may include a hierarchical reinforcement learner configured to use a recurrent neural network (e.g., a long short-term memory (LSTM) tensor flow network) along with one or more deep learning application programming interfaces within an interpreted language framework (e.g., Java). The RPA automatic enhancement system is an automation framework to automatically generate RPA scripts based on a user demonstration and protocols that generates an executable RPA script to perform user navigation. The RPA automatic enhancement system model includes fault tolerance so that a navigation route can be altered if an error is identified. The RPA automatic enhancement system includes an autoformer, which is used to covert the neural network generated output. The RPA automatic enhancement system also includes quality review engine processes to review the RPA script and will generate a quality audit report.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 shows an illustrative RPA automatic enhancement computing system environment, in accordance with one or more illustrative arrangements;

FIG. 2 shows a system including an RPA automatic enhancement computing system, in accordance with one or more illustrative arrangements;

FIG. 3 shows an illustrative captured video sequence and illustrative neural process graphs in accordance with one or more illustrative arrangements;

FIGS. 4A-C show an illustrative process for generating neural process graphs for an automated process in accordance with one or more illustrative arrangements;

FIG. 5 shows an illustrative process to convert a neural process graph to robotics process automation scripts in accordance with one or more illustrative arrangements;

FIG. 6 shows an illustrative process to automatically analyze generated robotics process automation scripts for quality in accordance with one or more illustrative arrangements; and

FIG. 7 shows an overview of an illustrative process to automatically generate robotics process automation scripts from captured video demonstration of a process in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

The above-described examples and arrangements are merely some example arrangements in which the systems described herein may be used. Various other arrangements employing aspects described herein may be used without departing from the invention.

Current RPA scripts are missing efficiencies included with human process activities. For example, an RPA robotic process (bot) may compare and/or copy values sequentially between user interface screens. However, humans process one or more values in parallel. Further, no provision to automatically load confirmation values exist when changed during a bot run. Instead, the bot must be restarted for the change to take effect. Further, current RPA bots may not include faster and efficient inbuilt scripts that allow for faster processing of transactions. Also, some RPA tools may not recognize changes made to application windows. Instead, the bot may stop and/or report an error, while humans would be able to adapt to changes identified on an application window. As such a need has been recognized for an improved RPA script generation system to automatically generate RPA scripts capable of performing actions with human-like efficiencies.

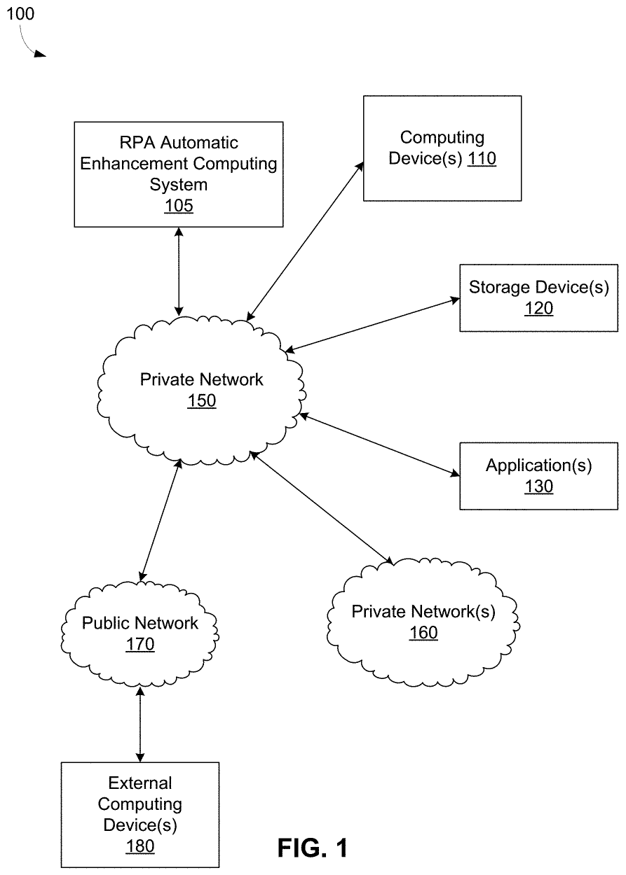

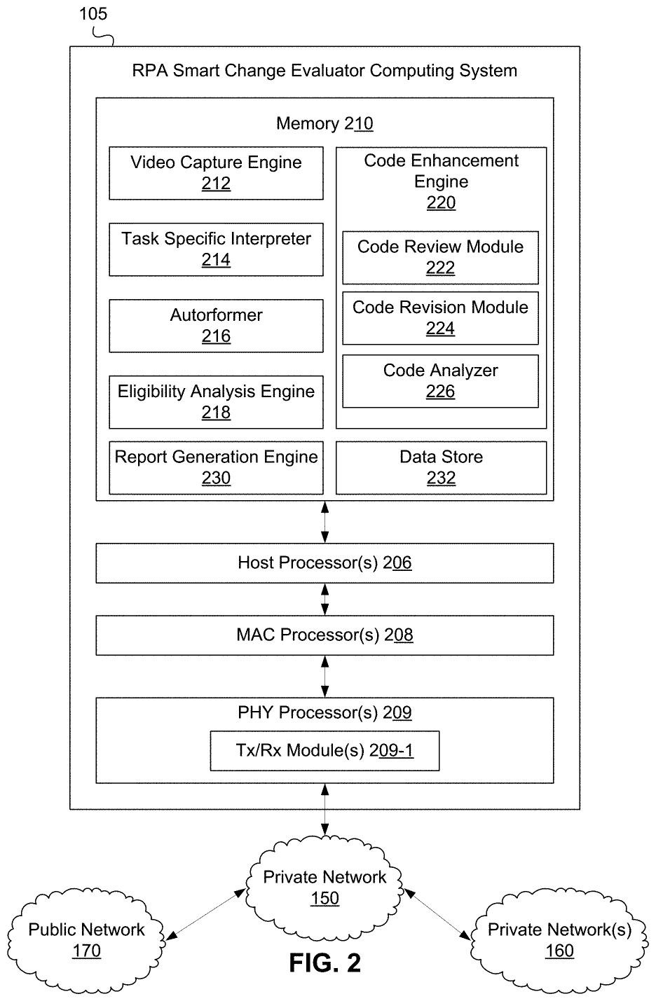

FIGS. 1 and 2 show an illustrative computing environment 100 for implementing aspects described herein, in accordance with one or more illustrative arrangements. Referring to FIG. 1, the computing environment 100 may comprise one or more devices (e.g., computer systems, communication devices, servers). The computing environment 100 may include, for example, an RPA automatic enhancement computing system 105, one or more computing device(s) 110, and one or more storage device(s) 120 linked over a private network 150. The storage device(s) 120 may comprise a database, for example, a relational database (e.g., Relational Database Management System (RDBMS), Structured Query Language (SQL), and the like). One or more application(s) 130 may operate on one or more computing devices or servers associated with the private network 150. The private network 150 may comprise an enterprise private network, for example.

The computing environment 100 may comprise one or more networks (e.g., public networks and/or private networks), which may interconnect one or more of the RPA automatic enhancement computing system 105, the computing device(s) 110, the storage device(s) 120, and/or one or more other devices and computing servers. One or more applications 130 may operate on one or more devices in the computing environment 100. The networks may use wired and/or wireless communication protocols. The private network 150 may be associated with, for example, an enterprise organization. The private network 150 may interconnect the RPA automatic enhancement computing system 105, the computing device(s) 110, the storage device(s) 120, and/or one or more other devices/servers which may be associated with the enterprise organization. The private network 150 may be linked to one or more other private network(s) 160 and/or a public network 170. The public network 170 may comprise the Internet and/or a cloud network. The private network 150 and the private network(s) 160 may correspond to, for example, a local area network (LAN), a wide area network (WAN), a peer-to-peer network, or the like.

A user in a context of the computing environment 100 may be, for example, an associated user (e.g., an employee, an affiliate, or the like) of the enterprise organization. An external user (e.g., a client) may utilize services being provided by the enterprise organization, and access one or more resources located within the private network 150 (e.g., via the public network 170). One or more users may operate one or more devices in the computing environment 100 to send messages to and/or receive messages from one or more other devices connected to or communicatively coupled with the computing environment 100. The enterprise organization may correspond to any government or private institution, an educational institution, a financial institution, a health services provider, a retailer, or the like.

As illustrated in greater detail below, the RPA automatic enhancement computing system 105 may comprise one or more computing devices configured to perform one or more of the functions described herein. The RPA automatic enhancement computing system 105 may comprise, for example, one or more computers (e.g., laptop computers, desktop computers, computing servers, server blades, or the like).

The computing device(s) 110 may comprise one or more of an enterprise application host platform, an enterprise user computing device, an administrator computing device, and/or other computing devices, platforms, and servers associated with the private network 150. The enterprise application host platform(s) may comprise one or more computing devices and/or other computer components (e.g., processors, memories, communication interfaces). The enterprise application host platform may be configured to host, execute, and/or otherwise provide one or more enterprise applications. The enterprise application host platform(s) may be configured, for example, to host, execute, and/or otherwise provide one or more transaction processing programs, user servicing programs, and/or other programs associated with an enterprise organization. The enterprise application host platform(s) may be configured to provide various enterprise and/or back-office computing functions for an enterprise organization. The enterprise application host platform(s) may comprise various servers and/or databases that store and/or otherwise maintain account information, such as financial/membership account information including account balances, transaction history, account owner information, and/or other information corresponding to one or more users (e.g., external users). The enterprise application host platform(s) may process and/or otherwise execute transactions on specific accounts based on commands and/or other information received from other computer systems comprising the computing environment 100. The enterprise application host platform(s) may receive data from the RPA automatic enhancement computing system 105, manipulate and/or otherwise process such data, and/or return processed data and/or other data to the RPA automatic enhancement computing system 105 and/or to other computer systems in the computing environment 100.

The enterprise user computing device may comprise a personal computing device (e.g., desktop computer, laptop computer) or mobile computing device (e.g., smartphone, tablet). The enterprise user computing device may be linked to and/or operated by a specific enterprise user (e.g., an employee or other affiliate of an enterprise organization).

The administrator computing device may comprise a personal computing device (e.g., desktop computer, laptop computer) or mobile computing device (e.g., smartphone, tablet). The administrator computing device may be linked to and/or operated by an administrative user (e.g., a network administrator of an enterprise organization). The administrator computing device may receive data from the RPA automatic enhancement computing system 105, manipulate and/or otherwise process such data, and/or return processed data and/or other data to the RPA automatic enhancement computing system 105 and/or to other computer systems in the computing environment 100. The administrator computing device may be configured to control or configure operation of the RPA automatic enhancement computing system 105.

The application(s) 130 may comprise transaction processing programs, user servicing programs, and/or other programs associated with an enterprise organization. The application(s) 130 may correspond to applications that provide various enterprise and/or back-office computing functions for an enterprise organization. The application(s) 130 may correspond to applications that facilitate storage, modification, and/or maintenance of account information, such as financial/membership account information including account balances, transaction history, account owner information, and/or other information corresponding to one or more users (e.g., external users). The application(s) 130 may process and/or otherwise execute transactions on specific accounts based on commands and/or other information received from other computer systems comprising the computing environment 100. The application(s) 130 may operate in a distributed manner across multiple computing devices (e.g., the computing device(s) 110) and/or servers, operate on a single computing device and/or server. The application(s) 130 may be used for execution of various operations corresponding to the one or more computing devices (e.g., the computing device(s) 110) and/or servers.

The storage device(s) 120 may comprise various memory devices such as hard disk drives, solid state drives, magnetic tape drives, or other electronically readable memory, and/or the like. The storage device(s) 120 may be used to store data corresponding to operation of one or more applications within the private network 150 (e.g., the application(s) 130), and/or computing devices (e.g., the computing device(s) 110). The storage device(s) 120 may receive data from the RPA automatic enhancement computing system 105, store the data, and/or transmit the data to the RPA automatic enhancement computing system 105 and/or to other computing systems in the computing environment 100.

The private network(s) 160 may have an architecture similar to an architecture of the private network 150. The private network(s) 160 may correspond to, for example, another enterprise organization that communicates data with the private network 150. The private network 150 may also be linked to the public network 170. The public network 170 may comprise the external computing device(s) 180. The external computer device(s) 180 may include a personal computing device (e.g., desktop computer, laptop computer) and/or a mobile computing device (e.g., smartphone, tablet). The external computing device(s) 180 may be linked to and/or operated by a user (e.g., a client, an affiliate, or an employee) of an enterprise organization associated with the private network 150. The user may interact with one or more enterprise resources while using the external computing device(s) 180 located outside of an enterprise firewall.

The RPA automatic enhancement computing system 105, the computing device(s) 110, the external computing device(s) 180, and/or one or more other systems/devices in the computing environment 100 may comprise any type of computing device capable of receiving input via a user interface, and may communicate the received input to one or more other computing devices. The RPA automatic enhancement computing system 105, the computing device(s) 110, the external computing device(s) 180, and/or the other systems/devices in the computing environment 100 may, in some instances, comprise server computers, desktop computers, laptop computers, tablet computers, smart phones, wearable devices, or the like that in turn comprise one or more processors, memories, communication interfaces, storage devices, and/or other components. Any and/or all of the RPA automatic enhancement computing system 105, the computing device(s) 110, the storage device(s) 120, and/or other systems/devices in the computing environment 100 may be, in some instances, special-purpose computing devices configured to perform specific functions.

Referring to FIG. 2, the RPA automatic enhancement computing system 105 may comprise one or more of host processor(s) 206, memory 210, medium access control (MAC) processor(s) 208, physical layer (PHY) processor(s) 209, transmit/receive (Tx/Rx) module(s) 209-1, or the like. One or more data buses may interconnect host processor(s) 206, memory 210, MAC processor(s) 208, PHY processor(s) 209, and/or Tx/Rx module(s) 209-1. The RPA automatic enhancement computing system 105 may be implemented using one or more integrated circuits (ICs), software, or a combination thereof, configured to operate as discussed below. The host processor(s) 206, the MAC processor(s) 208, and the PHY processor(s) 209 may be implemented, at least partially, on a single IC or multiple ICs. Memory 210 may be any memory such as a random-access memory (RAM), a read-only memory (ROM), a flash memory, or any other electronically readable memory, or the like.

Messages transmitted from and received at devices in the computing environment 100 may be encoded in one or more MAC data units and/or PHY data units. The MAC processor(s) 208 and/or the PHY processor(s) 209 of the RPA automatic enhancement computing system 105 may be configured to generate data units, and process received data units, that conform to any suitable wired and/or wireless communication protocol. For example, the MAC processor(s) 208 may be configured to implement MAC layer functions, and the PHY processor(s) 209 may be configured to implement PHY layer functions corresponding to the communication protocol. The MAC processor(s) 208 may, for example, generate MAC data units (e.g., MAC protocol data units (MPDUs)), and forward the MAC data units to the PHY processor(s) 209. The PHY processor(s) 209 may, for example, generate PHY data units (e.g., PHY protocol data units (PPDUs)) based on the MAC layer data units. The generated PHY data units may be transmitted via the Tx/Rx module(s) 209-1 over the private network 150, the private network(s) 160, and/or the public network 170. Similarly, the PHY processor(s) 209 may receive PHY data units from the Tx/Rx module(s) 209-1, extract MAC layer data units encapsulated within the PHY data units, and forward the extracted MAC data units to the MAC processor(s). The MAC processor(s) 208 may then process the MAC data units as forwarded by the PHY processor(s) 209.

One or more processors (e.g., the host processor(s) 206, the MAC processor(s) 208, the PHY processor(s) 209, and/or the like) of the RPA automatic enhancement computing system 105 may be configured to execute machine readable instructions stored in the memory 210. The memory 210 may comprise (i) one or more program modules/engines having instructions that when executed by the one or more processors cause the RPA automatic enhancement computing system 105 to perform one or more functions described herein, and/or (ii) one or more databases or datastores that may store and/or otherwise maintain information which may be used by the one or more program modules/engines and/or the one or more processors. The one or more program modules/engines and/or databases may be stored by and/or maintained in different memory units of the RPA automatic enhancement computing system 105 and/or by different computing devices that may form and/or otherwise make up the RPA automatic enhancement computing system 105. For example, memory 207 may have, store, and/or comprise a video capture engine 212, a task specific interpreter 214, an autoformer 216, an eligibility analysis engine 218, a code enhancement engine 220, a code review module 222, a code revision module 225, a code analyzer 226, a report generation engine 230, and/or at least one data store 232. The video capture engine 212, the task specific interpreter 214, the autoformer 216, the eligibility analysis engine 218, the code enhancement engine 220, the code review module 222, the code revision module 225, the code analyzer 226, and/or the report generation engine 230, as discussed in greater detail below. The data store 232 may comprise, for example, a relational database (e.g., Relational Database Management System (RDBMS), Structured Query Language (SQL) database, and the like). The data store 232 may include information pertaining to one or more processes performed in relation to one or more of the applications 130 via a video recording by the RPA automatic enhancement computing system 105 to identify behavior and path flow while a user completes components, elements, controls and/or other parameters in a process flow as provided through one or more of the applications 130. In some cases, the data store 132 may store information, neural network and/or machine learning models, and the like used in operation by one or more of the video capture engine 212, the task specific interpreter 214, the autoformer 216, the eligibility analysis engine 218, the code enhancement engine 220, the code review module 222, the code revision module 225, the code analyzer 226, and/or the report generation engine 230.

While FIGS. 1 and 2 illustrate the RPA automatic enhancement computing system 105 as being separate from other elements connected in the private network 150, in one or more other arrangements, the RPA automatic enhancement computing system 105 may be included in one or more of the computing device(s) 110, and/or other device/servers associated with the private network 150. Elements in the RPA automatic enhancement computing system 105 (e.g., host processor(s) 106, memory(s) 107, MAC processor(s) 108, PHY processor(s) 109, and Tx/Rx module(s) 109-1, one or more program modules and/or stored in memory(s) 107) may share hardware and/or software elements with and corresponding to, for example, one or more of the computing device(s) 110, and/or other device/servers associated with the private network 150.

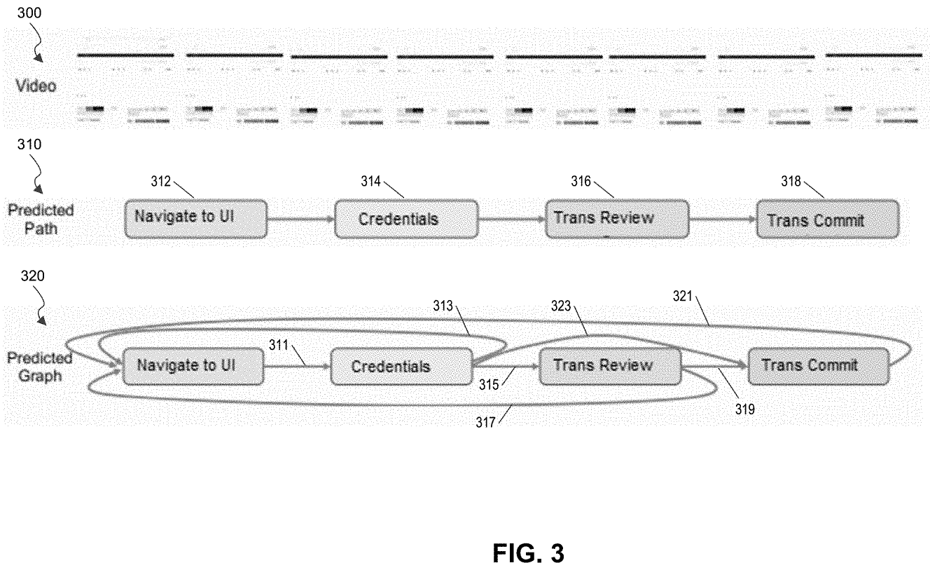

FIG. 3 shows an illustrative captured video sequence 300 and illustrative neural process graphs in accordance with one or more illustrative arrangements. Robotics process automation (RPA) is becoming a common tool used by enterprise organizations to automate performance of repetitive tasks. However, when moving these processes to RPA activities, many advantages for human performance of these tasks are lost. Humans have the ability take their learned experience from performance of an application and apply that knowledge to another application or task. For example, a task may involve entering data into multiple fields. Rather than entering the data into each field individually, a human may have learned that data may be copied into a certain format (e.g., a text file) and formatted for import into the application to fill all fields at once. By simply using a stepwise automation of such tasks, human creativity is lost when translating task requirements into RPA scripts. Currently, RPA scripts are often created based on a requirement specification or other documentation describing a process. By doing so, much of a human's creativity is lost. Here, the RPA automatic enhancement computing system 105 brings aspects of human creativity to RPA script generation my identifying processes like humans would do and not rely upon only documented requirements.

Initially, a video 300 of a process may be recorded to capture a human's interaction with an application or user interface, while performing a specific task. For example, a person may access an online form to generate an insurance claim. Here, the person may record information about a person, their policy and information corresponding to the claim. Once entered, the person may provide an input to initiate a next step, where an input is received from another system. For example, a user may click a submit button and a claim number may be returned. The video 300 may record the process. A visual representation of the recorded process may be created to provide a technologically agnostic visual representation of the process, such as with a neural program graph (NPG). The NPG 310 shows a visual representation of an NPG that may be created from documentation, where each step in the process (e.g., navigation of a user interface at 312, verification of credentials of the user at 314, a review of the transaction information at 316 and an initiation of the transaction at 318) may proceed linearly based on a sequence that each process is assumed to occur. However, the video 300 may be analyzed by the RPA automatic enhancement computing system 105 to identify steps in the process that a human may perform. For example, the user may navigate the user interface (UI) and then proceed to review entered credentials at 311. Once reviewed, the user may then navigate the UI to enter additional information at 313. When the information has been navigated and the credentials have been entered, the user may review the entered transaction information at 315 and may return to navigate the UI again at 317 to enter or modify certain information. When reviewed, the user may commit the data such as by using an input (e.g., an enter key, a mouse click, or the like) at 319. At 321, the user may navigate the UI again to review or modify information.

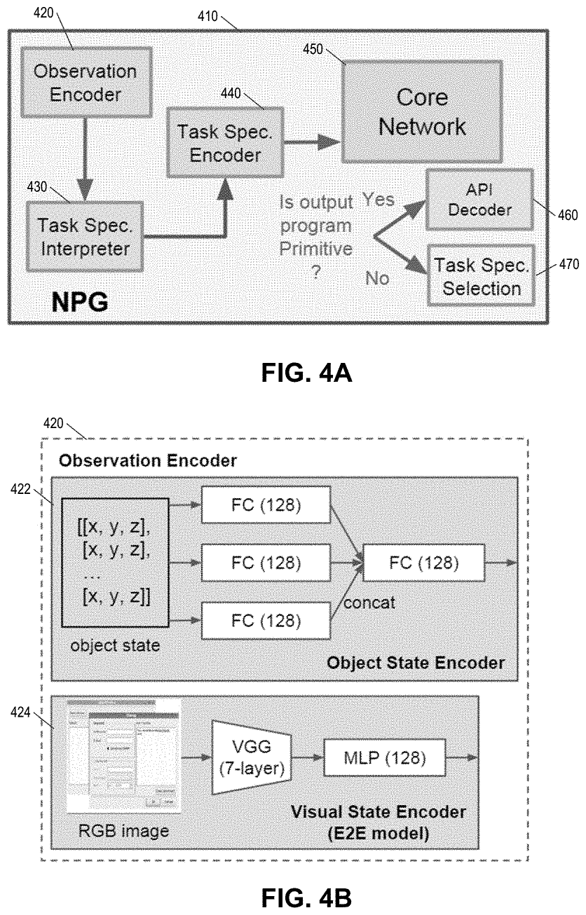

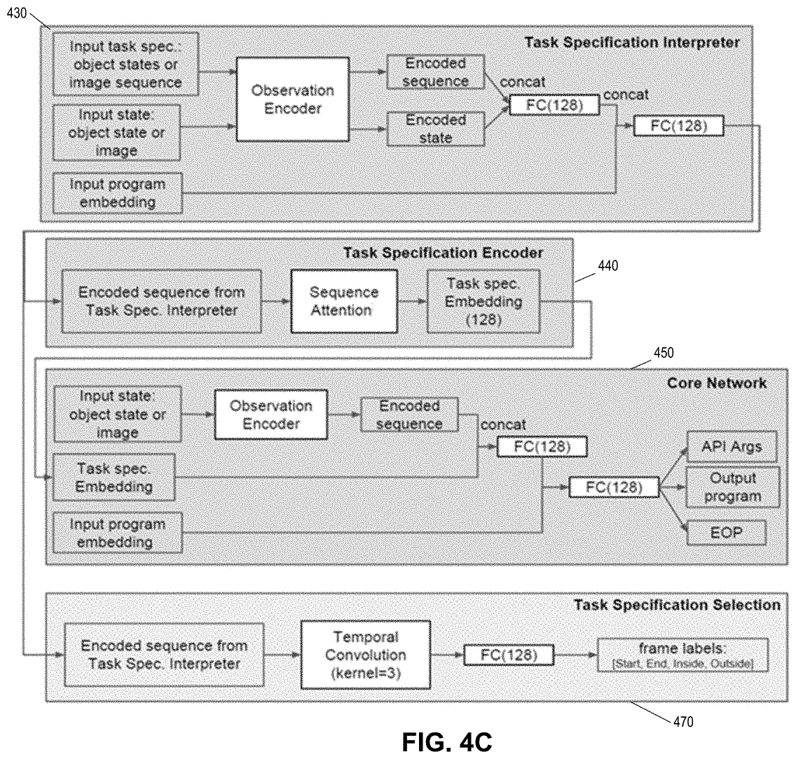

FIGS. 4A-C show an illustrative process for generating neural process graphs for an automated process in accordance with one or more illustrative arrangements. In FIG. 4A, the RPA automatic enhancement computing system 105 may include an observation encoder 420, a task specification interpreter, a task specification encoder 440, and a core network 450 to analyze captured video recordings of processes to be automated and generate an NPG. The RPA automatic enhancement computing system 105 may determine whether a program is primitive, if so, the RPA automatic enhancement computing system 105 may utilize an application programming interface API decoder. If not, the RPA automatic enhancement computing system 105 may use a task specification selection 470. In FIG. 4B, the observation encoder may include a visual state encoder 424 and an observation encoder 422. The visual state encoder may utilize an end to end (E2E) model (e.g., a deep learning neural network model) to train a complex learning system represented by a single model to represent the process. For example, the video 300 may be analyzed (e.g., frame by frame, time segment by time segment, and the like) such as with a Convolutional Neural Network (e.g., Visual Geometry Group 7-layer model (VGG 7)) to convert each image of the video 300 to a mathematical representation, such as a multilayer perceptron (MLP) feedforward artificial neural network. The MLP may comprise at least three layers of nodes, such as an input layer, a hidden layer and an output layer. Each node, other than the input nodes, may be a neuron that uses a nonlinear activation function, where MLP may use one or more supervised learnin techniques, such as backpropagation for training. In some cases, the MLP output from the visual state encoder 424 include 128 nodes. The observation encoder may analyze an object states of the process, where each object state is represented as a row in a 3×n object state matrix. The object state encoder may split the 3×n matrix into three 1×n matrices which may then be concatenated into a 1×n vector matrix representation of the object states.

In an illustrative example, an enterprise organization may desire to automate a simple web application via RPA, such as entry of data and receipt of a confirmation after entry. For example, an illustrative web application may include entry of user and user insurance policy information regarding an insurance claim, where upon entry and selection of a “submit” button a confirmation is received, e.g., a claim number. Here, the user enters information into the application, such as address information, information about the insurance policy and information about a desired insurance claim. The user may enter the information into the application via a form or forms that may include navigation between different user interface screens. Upon entry, such as via a mouse click on a UI button, the application may process and validate the information and return a claim number if the information was entered correctly, or an error that may indicate incomplete or inaccurate entry of information or the like. When recorded, a video of such an entry process may capture paths navigated to access functionality, user interaction with the provided functionality, method and form of information entry (e.g., text, numerical, selection, check box, button, and the like) and any dependencies on previous actions or data entries and/or selections. In some cases, such as when a neural network learning model is being trained, a same process may be recorded multiple times as performed by the same or different individuals. As such, different possible combination of entries and/or navigation paths may be identified and may be applied when automating a future process. During the video analysis, a visual representation of the process may be captured or described so that a sequence may be preserved correctly. In some cases, the order of operation of nodes in the sequence may be performed in a different order. As can be seen in the visual representations of the illustrative process shown in FIG. 3, main components of an interaction sequence may be captured, such as UI navigation 312, entry of information (e.g., credentials 314), review of information (e.g., transaction review 316), and an action (e.g., transaction commit 318). Also during the video review, different properties of the components of the user interface may be automatically captured, such as a property of a component (e.g., a text box) and/or an input type for each component (e.g., a mouse click, a text entry, a list selection, and the like). For example, the observation encoder 420 of the RPA automatic enhancement computing system 105 may capture and identify, for a specific application, a sequence of events and application properties, such as visual clues in the user interface, properties of the components, and an input type. For example, visual labels included in the user interface may be captured (e.g., field names, UI page names, and the like), an indication of where a node or component falls in an overall sequence and any dependencies on other functionality, UI properties (e.g., a UI component type), and a way of interacting with the particular component.

FIG. 4C shows an illustrative process performed by the RPA automatic enhancement computing system 105 when analyzing and interpreting a task workflow as captured by the observation encoder 420. For instance, a task specification interpreter 430 may process information processed by the observation encoder 420 as an inputs. The task specification interpreter 430 may receive one or more of an input task specification defining objects states and/or an image sequence, an input state, such as an object state or image, and/or an input program defining the user interface, such as hypertext markup language (HTML) code or the like. Each input may be converted into a vector, such as columnar matrix vector of a number of elements (e.g., 128 elements or rows) by a wholly connected neural network. The columnar matrix vectors may then be concatenated. For example, as shown in FIG. 4C, input task state information (e.g., an object state list or image) may be fed as input into the observation encoder along with, optionally, documentation associated with the process to be automated (e.g., an input task specification). In an illustrative example, image frames, documentation, metadata may be processed into vector notation and then concatenated. The observation encoder outputs an encoded sequence and an encoded state as columnar matrix vectors, which are then concatenated with the resultant being concatenated with a columnar matrix vector representative of the input program code for the UI. Once completed, the output of the observation may be a 2-column matrix, where a first column corresponds to an input sequence and the input specification, and the second column may comprise a vector representation of the captured images of the recorded process. For simple processes, 1 or two images may be used such as to capture a form fill functionality. For more complex processes, many more images may be captured and processed. Additionally, the task specification interpreter 430 may convert html coding or another UI coding into another columnar matrix vector (e.g., 1×128 matrix vector). This may be concatenated with the 2-column matrix vector to form a 3-column matrix vector. If the optional documentation is not analyzed, the 3-column matrix vector may include a column of zeros.

The task specification encoder 440 may receive the encoded sequence (e.g., the 3-column matrix vector) form the task specification interpreter 430 as an input. A sequence attention module may process the input matrix vector by concatenating together, in a row-wise manner, each row of the 3-column matrix vector to convert the vector into a mathematical representation of the input information for processing by the neural network with the result being stored as a columnar matrix vector (e.g., 1×128 columnar matrix vector). Here, the 3 data vectors are merged into a single columnar matrix vector with 128 elements. The refined columnar vector represents the mapping, which may be trained through a sequence attention process, documentation to image comparison and image to coding, to establish the process representation with attention to a sequence of operation. The resulting matrix is a 1×128 element columnar matrix vector. In some cases, the images of the video and the test specification may be analyzed with the core neural network, where the image and the input program may be analyzed at the same time and may be concatenated together. The core neural network 450 may produce a graphical representation of the process to be automated, such as an NPG. An interaction sequence represented by the NPG may be derived from the UI properties obtained from the program code, inputs to the API, visual levels identified from another process. A temporal convolution may provide a time-based interaction forgiven times (t), with reference to specific components. An encoder sequence may be paired with visual clues to identifier where the components are located on a screen and start times and end times. The NPG may incorporate the API inputs, the UI properties, frame labels, and an interaction sequence. The NPG is output as a technology agnostic representation, where the autoformer may be used to transform the NPG to a specific technology and may subsequently generate or trigger generation of the RPA scripts to automate the process. The conversion of the 3×128 element matrix vector to a single 1×128 element matrix vector is performed through a row-by-row combination and/or may be sequence dependent, where the commination of features may be dependent on the sequence of operation. As such, a same process, performed and analyzed using a different sequence, may output a different NPG. When performing the conversion of the 3×128 matrix vector, the columns may be combined through one or more mathematical operations including determining a mean, applying a non-linear equation, a sum and the like, to combine the columns after determining a similarity. In some cases, a cosign similarity may be used to determine an angular distance between vectors, where a vector product may be divided by a magnitude of the vector. To indicate an end of the NPG, an end of process (EOP) label may be included. The task specification selection 470 may process an encoded sequence from the task specification interpreter 430 and may perform a temporal convolution to output a columnar vector corresponding to frame labels, such as start, end, include, outside, and the like.

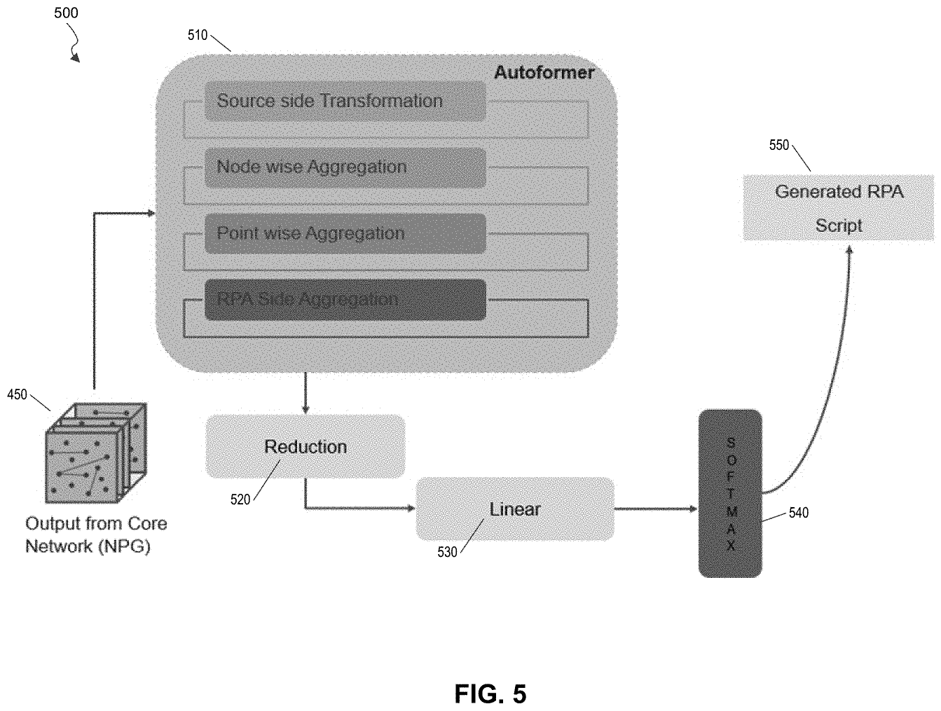

FIG. 5 shows an illustrative process to convert a neural process graph to robotics process automation scripts via an autoformer 510 in accordance with one or more illustrative arrangements. As mentioned above, output from the core network 450, the NPG, may be fed to an autoformer 510 to convert the technology agnostic NPG representation of the automated process to a format capable of being run on a particular RPA technology platform. For example, the autoformer 510 may perform a source side transformation process, a node wise aggregation process, a point-wise aggregation process, and an RPA-side aggregation process. The autoformer t10 is an engineering framework capable of processing a graphical algorithm (e.g., the NPG) by traversing the NPG in a node-by-node manner such that each node is accessed. The source side transformation process identifies how each node is related to the others, the node-wise aggregation process identifies each component (e.g., a field, a button, and the like) included in each node and its associated characteristics (text, drop down menu, and the like). The point-wise aggregation identifies limitations, such a maximum length, a time limit and identifies exception conditions. When consolidated, the RPA side aggregation engine may process configuration and scripts to be stitched together to perform the process.

Once the NPG has been transformed by the autoformer 510, the reduction engine 520 may identify redundant activities shown in the video (e.g., such as multiple views or modifications to a same data field, scrolling without changing any data, and the like). The reduction engine 520 may then remove the identified redundant components before the linear engine 530 stiches the components and activities together. In some cases, human editing may be performed, such as for quality control and/or additional training, such as through an interaction module (e.g., the softmax engine 540). Once the created, the RPA script generation engine 550 may generate an RPA script based on the optimized autotransformed NPG information and/or a configuration file associated with an RPA platform.

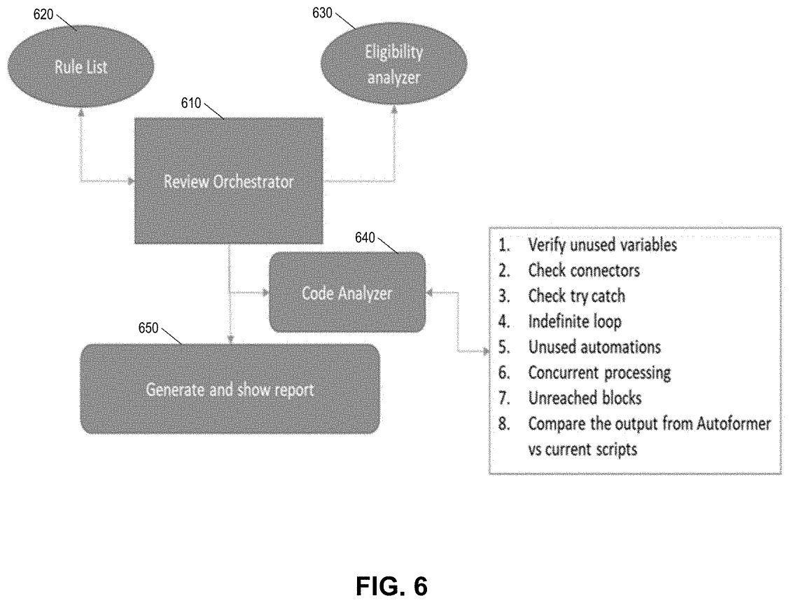

FIG. 6 shows an illustrative process to automatically analyze generated robotics process automation scripts for quality in accordance with one or more illustrative arrangements. In some cases the RPA automatic enhancement computing system 105 may include a review orchestrator 610, a rule list data store 620, an eligibility analyzer 630, a code analyzer 640, and a report generation system 650. The review orchestrator 610 may coordinate automated and comprehensive review of the automatically generated RPA script to ensure connections are established between NPG nodes and exceptions are handled correctly. The review orchestrator 610 may also determine whether independent blocks have been created, but remain unused. Indeed, the review orchestrator 610 may compare the automated generated output with a script generated with human designed rules. The rule list data store 620 may store a list or lists of rules that may be applied by the code analyzer 640 against the code during a review, such as to determine whether certain components, operations, elements and the like are present. In some cases, the list of rules may be defined in a spreadsheet or an extensible markup language (xml) file. If errors are present, the information may be communicated as feedback to the NPG for continuous improvement of the process, to identify and correct potential errors and/or provide other troubleshooting operations. As such, the RPA automatic enhancement computing system 105 intelligently creates feedback to improve the NPG. In some cases, the code analyzer 640 and/or the eligibility analyzer 630 may operate using one or more thresholds, such that when an automatically generated RPA script has met the threshold condition (e.g., under five errors, no unhandled exceptions, and the like) the RPA script may be released and automatically communicated to a production system for operation. In some cases, the eligibility analyzer may choose a list of files which may be eligible for code review. The code analyzer may analyze the code based on a configuration file for a target RPA system. The code analyzer may perform a series of checks, such as (1) verify unused variables, (2) check connectors, (3) check a “try” catch, (4) identify whether infinite loop conditions may be possible, (5) identify unused automation features, (6) identify instances of concurrent processing, (7) identify unreached blocks, (8) compare the output from the autoformer vs current operational RPA scripts, and/or the like.

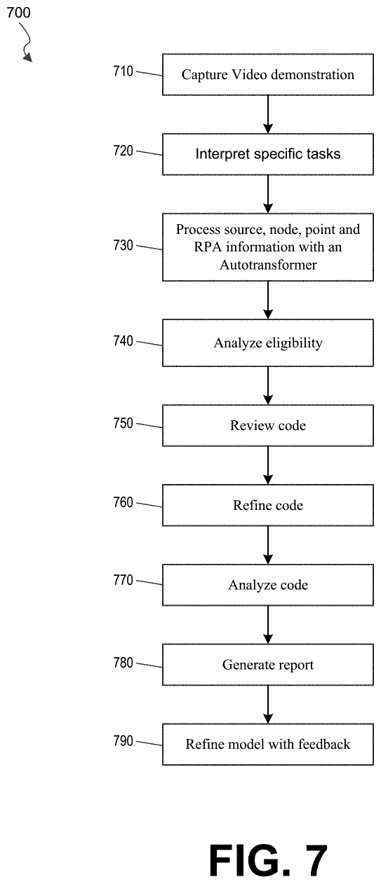

FIG. 7 shows an overview of an illustrative process 500 to automatically generate robotics process automation scripts from captured video demonstration of a process in accordance with one or more aspects described herein.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, Application-Specific Integrated Circuits (ASICs), Field Programmable Gate Arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, one or more steps described with respect to one figure may be used in combination with one or more steps described with respect to another figure, and/or one or more depicted steps may be optional in accordance with aspects of the disclosure.

1. A computing platform comprising:
a processor; and
non-transitory memory storing instructions that, when executed by the processor, cause the computing platform to:
capture a video recording of an operation of a computing process to be automated;
generate, by a task specification interpreter, a mathematical representation of the computing process based on images captured during the video recording of the operation of the computing process and code associated with the computing process;
generate, by a core neural network, a neural program graph NPG representation of the computing process;
transform, by an autoformer, the NPG representation of the computing process into an RPA file having a format corresponding to a target robotics process automation (RPA) system; and
automatically converting the RPA file into an RPA script.

2. The computing platform of claim 1, wherein the computing process comprises a web-based application.

3. The computing platform of claim 1, wherein the mathematical representation comprises a columnar matrix vector.

4. The computing platform of claim 3, wherein the columnar matrix vector comprises a 1×128 columnar matrix vector.

5. The computing platform of claim 1, wherein the instructions, when processed by the processor, further cause the computing platform to generate the mathematical representation of the computing process based on documentation of object states of the process.

6. The computing platform of claim 1, wherein the instructions, when processed by the processor, further cause the computing platform to transform, by the autoformer, the NPG representation of the computing process into the RPA file via a source-side transformation, a node-wise aggregation, a point-wise aggregation, and an RPA side aggregation.

7. A non-transitory computer readable medium storing instructions that, when executed by a processor, cause a computing device to:
capture a video recording of an operation of a computing process to be automated;
generate, by a task specification interpreter, a mathematical representation of the computing process based on images captured during the video recording of the operation of the computing process and code associated with the computing process;
generate, by a core neural network, a neural program graph NPG representation of the computing process;
transform, by an autoformer, the NPG representation of the computing process into an RPA file having a format corresponding to a target robotics process automation (RPA) system; and
automatically convert the RPA file into an RPA script.

8. The non-transitory computer readable medium of claim 7, wherein the computing process comprises a web-based application.

9. The non-transitory computer readable medium of claim 7, wherein the mathematical representation comprises a columnar matrix vector.

10. The non-transitory computer readable medium of claim 9, wherein the columnar matrix vector comprises a 1×128 columnar matrix vector.

11. The non-transitory computer readable medium of claim 7, wherein the instructions, when processed by the processor, further cause the computing device to generate the mathematical representation of the computing process based on documentation of object states of the process.

12. The non-transitory computer readable medium of claim 7, wherein the instructions, when processed by the processor, further cause the computing device to transform, by the autoformer, the NPG representation of the computing process into the RPA file via a source-side transformation, a node-wise aggregation, a point-wise aggregation, and an RPA side aggregation.

13. A method comprising:
capturing, by an observation encoder, a video recording of an operation of a computing process to be automated;
generating, by a task specification interpreter, a mathematical representation of the computing process based on images captured during the video recording of the operation of the computing process and code associated with the computing process;
generating, by a core neural network, a neural program graph NPG representation of the computing process;
transforming, by an autoformer, the NPG representation of the computing process into an RPA file having a format corresponding to a target robotics process automation (RPA) system;
automatically converting the RPA file into an RPA script; and
automatically verifying, by a review orchestrator, the RPA script based on a configuration of the RPA system.

14. The method of claim 13, wherein automatically verifying the RPA script based on the configuration of the RPA system comprises identifying unused variables, connectors, or unreached blocks.

15. The method of claim 13, wherein the computing process comprises a web-based application.

16. The method of claim 13, wherein the mathematical representation comprises a columnar matrix vector.

17. The method of claim 16, wherein the columnar matrix vector comprises a 1×128 columnar matrix vector.

18. The method of claim 13, comprising generating the mathematical representation of the computing process based on documentation of object states of the process.

19. The method of claim 13, comprising transforming, by the autoformer, the NPG representation of the computing process into the RPA file via a source-side transformation, a node-wise aggregation, a point-wise aggregation, and an RPA side aggregation.
